(19) United States
(12) Patent Application Publication
(10) Pub. No.: US 2023/0218011 A1
(43) Pub. Date: Jul. 13, 2023

(54) SYSTEM AND PROCESS FOR PREPARING AEROSOL-GENERATING COMPONENTS

(71) Applicant: Nicoventures Trading Limited, London (GB)

(72) Inventors: Shasa HARRIS, London (GB); Howard ROUGHLEY, London (GB); Gustavo MACIEL, London (GB)

(21) Appl. No.: 17/996,384

(22) PCT Filed: Apr. 23, 2021
(86) PCT No.: PCT/GB2021/050988

§ 371 Date: Oct. 17, 2022

(30) Foreign Application Priority Data
Apr. 23, 2020 (GB) 2005966.3

(51) Int. Cl. A24F 40/70; B33Y 10/00; B33Y 80/00; B33Y 50/02

(52) U.S. Cl. CPC A24F 40/70; B33Y 10/00; B33Y 80/00; B33Y 50/02

(57) ABSTRACT

A system for preparing an aerosol-generating component customized by a user including an apparatus for using one or more feedstock materials in an additive manufacturing process, wherein the one or more feedstock material is selected and formed into an aerosolizable substrate by the additive manufacturing process in accordance with instructions provided by the user. There is also provided a process for producing a customized aerosol-generating component, the process including forming one or more feedstock materials into the aerosol-generating component by an additive manufacturing process in accordance with instructions provided by the user.

### PRIORITY CLAIM

The present application is a National Phase entry of PCT Application No. PCT/GB2021/050988, filed Apr. 23, 2021, which claims priority from GB Application No. 2005966.3, filed Apr. 23, 2020, each of which is hereby fully incorporated herein by reference.

### TECHNICAL FIELD

The invention relates to systems for preparing aerosol-generating components for inclusion in an aerosol provision system, such as a device for heating aerosol-generating material to volatilise at least one component of the material. The invention also relates to processes for preparing such components.

### BACKGROUND

Aerosol-generating material may include a variety of different active substances and/or flavors and a user selects aerosol-generating material to provide the desired user experience.

### SUMMARY

In accordance with some embodiments described herein, there is provided a system for preparing an aerosol-generating component customised by a user, comprising an apparatus for using one or more feedstock materials in an additive manufacturing process, wherein one or more feedstock material is selected and formed into the aerosol-generating component by the additive manufacturing process in accordance with instructions provided by the user.

In some embodiments, the aerosol-generating component comprises an aerosol generating material.

In some embodiments, the additive manufacturing process forms a three-dimensional object from the feedstock material using a computer-aided design (CAD) model.

In some embodiments, the additive manufacturing process is a 3D printing process depositing layer upon layer of feedstock material.

In some embodiments, the system comprises an array of feedstock materials.

In some embodiments, the system prepares one or more feedstock materials in accordance with instructions provided by the user.

In some embodiments, the system incorporates two or more feedstock materials into the aerosol-generating component in accordance with instructions provided by the user.

In some embodiments, the system cures the aerosol-generating component formed by the additive manufacturing process.

In some embodiments, the system incorporates the aerosol-generating component into a consumable in accordance with instructions provided by the user.

In some embodiments, the system is a vending machine.

In some embodiments, the system is a domestic appliance.

In accordance with some embodiments described herein, there is provided a process for producing a customised aerosol-generating component, the process comprising forming one or more feedstock materials into the aerosol-generating component by an additive manufacturing process in accordance with instructions provided by the user.

In some embodiments, the aerosol-generating component comprises an aerosol generating material

In some embodiments, the additive manufacturing process forms a three-dimensional object from the feedstock material using a computer-aided design (CAD) model.

In some embodiments, the additive manufacturing process is a 3D printing process depositing layer upon layer of feedstock material.

In some embodiments, the process includes the step of preparing feedstock materials in accordance with instructions provided by the user.

In some embodiments, the process forms the aerosol-generating component from two or more feedstock materials in accordance with instructions provided by the user.

In some embodiments, the process further comprises curing the aerosol-generating component formed by the additive manufacturing process.

### BRIEF DESCRIPTION OF THE DRAWINGS

Embodiments of the invention will now be described, by way of example only, with reference to accompanying drawings, in which:

FIG. 1 is a flow chart illustrating the functioning of a system or process as described herein; and

FIG. 2 is a schematic illustration of a system as described herein.

### DETAILED DESCRIPTION OF THE DRAWINGS

In some aspects, the invention relates to a system for preparing an aerosol-generating component customized by a user, the system comprising one or more feedstock materials and an apparatus for using the feedstock material in an additive manufacturing process. One or more feedstock material is selected and formed into an aerosol-generating component by the additive manufacturing process in accordance with instructions provided by the user.

In some embodiments, the aerosol-generating component comprises an aerosol generating material. Aerosol-generating material is a material that is capable of generating aerosol, for example when heated, irradiated or energized in any other way.

As used herein, the aerosol-generating components are components that are ready for use in a delivery system, such as a non-combustible aerosol provision system. This means that the aerosol-generating component produced by the system is ready to be used in a delivery system, without the need for any further adaptation or processing.

The additive manufacturing process used to form the aerosol-generating components provides important flexibility with regard to the three dimensional shape of the aerosol-generating component produced using the systems and processes disclosed herein. For example, in some embodiments it is desirable to provide a component with a large surface area and the additive manufacturing process may be used to produce components with channels and/or with intricate cross-sectional shapes (such as Y-, X- or star-shaped) to maximize the surface area whilst still retaining the necessary strength and stability of the components.

Additive manufacturing builds a three-dimensional object from a computer-aided design (CAD) model, usually by successively adding material layer by layer. Various processes may be used to join or solidify material under the control of a computer to create a three-dimensional object.

The term “additive-manufacturing” is used herein to refer to a variety of processes, including, for example, printing processes that deposit a material with dispensing heads layer by layer (“3D printing”).

The system provides the user with the ability to create customized aerosol-generating components. One or more of the size, shape and make-up of the component may be selected by the user. The user may also choose to create the aerosol-generating components as and when they are required.

In some aspects, the invention relates to a process for producing a customised aerosol-generating component, the process comprising forming one or more feedstock materials into the aerosol-generating component by an additive manufacturing process in accordance with instructions provided by the user.

The process provides the user with the ability to create customized aerosol-generating components. One or more of the size, shape and make-up of the component may be selected by the user. The user may also choose to create the aerosol-generating components as and when they are required.

In some embodiments, the process involves the use of an additive manufacturing apparatus, such as a 3D printer. The apparatus uses the feedstock material to form the aerosol-generating component, for example under the control of a computer program.

In some embodiments of the system or the process, the user selects the feedstock material used to form the aerosol-generating component. Additionally or alternatively, the user selects the size and/or shape of the aerosol-generating component to be formed.

In some embodiments, the user selects one or more feedstock materials from an array of feedstock materials provided. In other embodiments, the user may create one or more different feedstock materials by selecting components to be mixed to provide the one or more feedstock materials. For example, a basic feedstock material may be provided and the user may select one or more additional components to be added to this to create a customized feedstock that will generate an aerosol with the desired properties. The additional components may include active substances, flavors and other functional components.

Thus, the feedstock and the aerosol-generating material may comprise one or more active substances and/or flavors, one or more aerosol-former materials, and optionally one or more other functional material.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

In some embodiments, the active substance may comprise or be derived from one or more botanicals or constituents, derivatives or extracts thereof. As used herein, the term “botanical” includes any material derived from plants including, but not limited to, extracts, leaves, bark, fibres, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citratac.v., Mentha piperita c.v, Mentha spicata crispa, Mentha cardifolia, Mentha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the active substance is nicotine. This may be provided in the feedstock and aerosol-generating material in the form of particles of tobacco material, a tobacco extract, and/or a purified or synthetic form of nicotine.

In some embodiments, the feedstock and the aerosol-generating material comprise a flavor.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

In some embodiments, the feedstock and the aerosol-generating material comprise an aerosol-former material. The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

In some embodiments, the feedstock and aerosol-generating material comprise one or more functional materials. The one or more other functional materials may comprise one or more of pH regulators, coloring agents, preservatives, binders, fillers, stabilizers, and/or antioxidants.

Suitable binders include, for example, pectin, guar gum, fruit pectin, citrus pectin, tobacco pectin, hydroxyethyl guar gum, hydroxypropyl guar gum, hydroxyethyl locust bean gum, hydroxypropyl locust bean gum, alginate, starch, modified starch, derivatized starch, methyl cellulose, ethyl cellulose, ethylhydroxymethyl cellulose, carboxymethyl cellulose, tamarind gum, dextran, pullalon, konjac flour or xanthan gum.

Once the one or more feedstock has been selected, an apparatus uses the feedstock in an additive manufacturing process to form a three dimensional solid aerosol-generating component. One or more feedstock materials may be used to form a single aerosol-generating component. Where two or more different feedstocks are selected, these may be used as a mixture, such as a homogenous mixture, to form the aerosol-generating component. Alternatively or in addition, different feedstocks of mixtures thereof may be used sequentially, to form different parts or layers of the aerosol-generating component from the different aerosol-generating materials. These variable features of the resultant aerosol-generating component may be selected by the user of the system.

In some embodiments, the shape or form of the aerosol-generating component may also be selected. Aerosol-generating components may be used in a variety of different delivery systems and the shape and/or size of the component to be heated in such systems vary. In some embodiments, the user of the system can select the shape and/or size of the aerosol-generating component being prepared, for example to match the delivery system the component is to be used in.

As used herein, the term “delivery system” is intended to encompass systems that deliver at least one substance to a user, and includes:
combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokeable material); and
non-combustible aerosol provision systems that release compounds from an aerosol-generating material without combusting the aerosol-generating material, such as tobacco heating products, and hybrid systems to generate aerosol using a combination of aerosol-generating materials.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure. In some embodiments, the aerosol-generating material comprises an aerosol-generating component prepared by the systems or processes disclosed herein.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

In some embodiments, the apparatus for performing the additive manufacturing process is an apparatus that may be used to sequentially deposit feedstock material layer upon layer to form a three-dimensional object under the control of a computer program. In particular embodiments, the additive manufacturing process is 3D printing and suitable apparatus for performing this include 3D printers having a print head that lays down multiple layers of feedstock material to form a three-dimensional object. In general, print heads contain chambers that get fed the feedstock to be deposited and nozzles that dispense the feedstock in a highly controlled manner.

In some embodiments, the feedstock used to prepare the aerosol-generating components is a paste or slurry. In such embodiments, the additive manufacturing process is a paste or slurry extrusion 3D printing process.

Under computer control based upon the instructions of the user, the system according to the present disclosure prepares an aerosol-generating component using the selected feedstock or selected feedstock ingredients, by depositing layers of the feedstock in a controlled manner to provide an aerosol-generating component of the desired shape and size.

The viscosity of the feedstock and properties of the additive manufacturing apparatus, such as the size of the nozzle aperture and/or the speed at which the feedstock is delivered, can be optimised to allow the features of the aerosol-generating component to be tailored to its proposed use.

In an optional further step, the aerosol-generating component is treated following the additive manufacturing process. For example, the component prepared by the additive manufacturing process may be subsequently cured. Curing may, in some embodiments, involve exposure to a suitable heat source, for example, hot air, infrared, laser or plasma jet.

In some embodiments, the system disclosed herein includes an interface enabling the user to provide instructions to the system relating to the feedstock to be used to prepare the aerosol-generating component and/or relating to the size and/or shape of the aerosol-generating component. In some embodiments, the system provides a selection of product options, for example combining one or more of an active, a flavor and a size and shape. The size and shape may be defined in terms of the aerosol provision system the aerosol-generating component is to be used in.

In some embodiments, the system disclosed herein is a vending machine. In some embodiments, the vending machine includes a means for accepting payment from the user. In other embodiments, the system is a device suitable for use in the home (a household device).

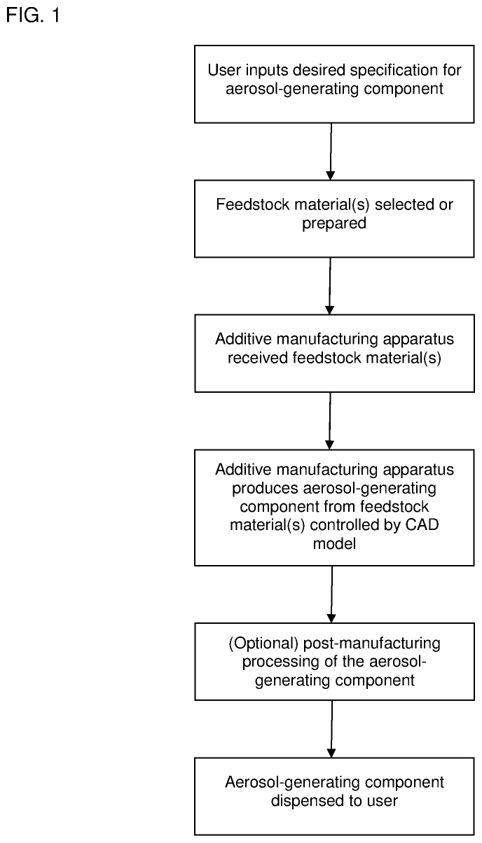

FIG. 1 is a flow chart showing the steps of the processes described herein and the functioning of the system as described herein. Firstly, the user inputs a specification for the aerosol-generating component to be manufactured. This includes information such as the make-up of the component and the size and shape of the component. These may, for example, be provided as pre-programed options that the user may select.

As a result of this information, the system selects or prepares one or more feedstock materials to be used to form the aerosol-generating component. For example, the feedstock includes the active, flavor or other components in accordance with the make-up of the component desired by the user.

Next, the additive manufacturing apparatus, such as a 3D printer, receives the feedstock. The apparatus then uses the feedstock to produce the aerosol-generating component with the appropriate shape and dimensions according to the user instructions. The apparatus is controlled by software that translates the user input into instructions to form the appropriate three-dimensional form, using the feedstock material.

In an optional step, the product of the additive manufacturing step is processed. For example, it may be cured or otherwise treated.

Finally, the finished aerosol-generating component is dispensed to the user. In some embodiments, the component is ready for use in an appropriate delivery system.

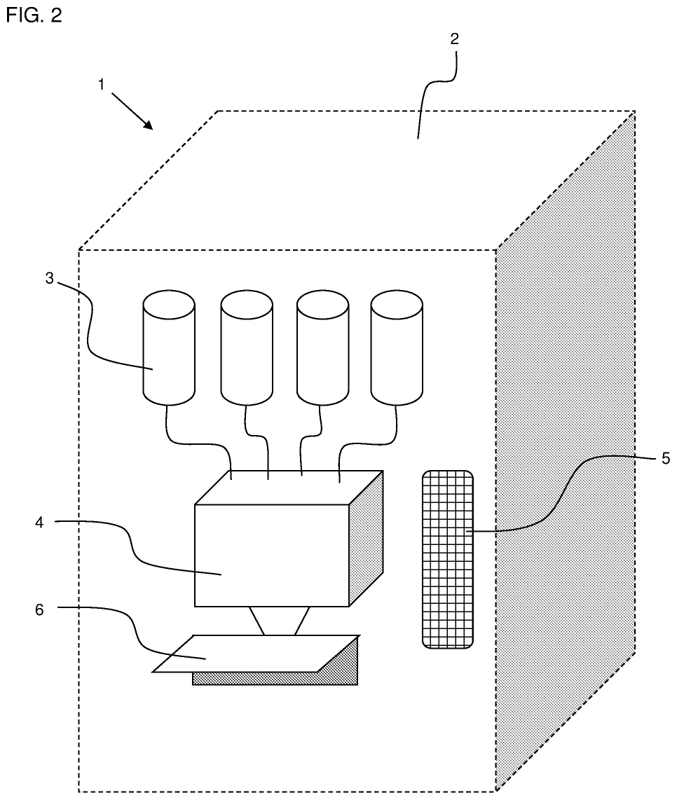

An example of a vending machine 1 is shown schematically in FIG. 2. Within the housing 2, there are provided reservoirs 3 containing feedstock material. The reservoirs feed the feedstock material to an additive manufacturing apparatus 4. The flow of the feedstock material from the reservoirs to the additive manufacturing apparatus, and the apparatus, are controlled based upon the instruction provided by the user via the user interface 5. The aerosol-generating component produced by the vending machine 1 is dispensed to the user through the access aperture 6.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A system for preparing an aerosol-generating component customized by a user, comprising an apparatus for using one or more feedstock materials in an additive manufacturing process, wherein one or more feedstock material is selected and formed into the aerosol-generating component by the additive manufacturing process in accordance with instructions provided by the user.

2. A system as claimed in claim 1, wherein the aerosol-generating component comprises an aerosol generating material.

3. A system as claimed in claim 1, wherein the additive manufacturing process forms a three-dimensional object from the feedstock material using a computer-aided design (CAD) model.

4. A system as claimed in any one of claims claim 1, wherein the additive manufacturing process is a 3D printing process depositing layer upon layer of feedstock material.

5. A system as claimed in claim 1, wherein the system comprises an array of feedstock materials.

6. A system as claimed in claim 1, wherein the system prepares one or more feedstock materials in accordance with instructions provided by the user.

7. A system as claimed in claim 1, wherein the system incorporates two or more feedstock materials into the aerosol-generating component in accordance with instructions provided by the user.

8. A system as claimed in claim 1, wherein the system cures the aerosol-generating component formed by the additive manufacturing process.

9. A system as claimed in claim 1, wherein the system incorporates the aerosol-generating component into a consumable in accordance with instructions provided by the user.

10. A system as claimed in claim 1, wherein the system is a vending machine.

11. A system as claimed in claim 1, wherein the system is a domestic appliance.

12. A process for producing a customized aerosol-generating component, the process comprising forming one or more feedstock materials into the aerosol-generating component by an additive manufacturing process in accordance with instructions provided by the user.

13. A process as claimed in claim 12, wherein the aerosol-generating component comprises an aerosol generating material.

14. A process as claimed in claim 12, wherein the additive manufacturing process forms a three-dimensional object from the feedstock material using a computer-aided design (CAD) model.

15. A process as claimed in claim 12, wherein the additive manufacturing process is a 3D printing process depositing layer upon layer of feedstock material.

16. A process as claimed in claim 12, wherein the process includes the step of preparing feedstock materials in accordance with instructions provided by the user.

17. A process as claimed in claim 12, wherein the process forms the aerosol-generating component from two or more feedstock materials in accordance with instructions provided by the user.

18. A process as claimed in claim 12, wherein the process further comprises curing the aerosol-generating component formed by the additive manufacturing process.
